(19) United States
(12) Patent Application Publication
(10) Pub. No.: US 2020/0104092 A1
(43) Pub. Date: Apr. 2, 2020

(54) Group Slideshow

(71) Applicant: BublUp, Inc., Arlington, VA (US)

(72) Inventors: Alain Cohen, McLean, VA (US); Marc Cohen, McLean, VA (US); Yevgeny Gurevich, Bethesda, MD (US)

(21) Appl. No.: 16/590,071

(22) Filed: Oct. 1, 2019

Related U.S. Application Data
(60) Provisional application No. 62/740,264, filed on Oct. 2, 2018.

(51) Int. Cl. G06F 3/14; G06F 3/0482; G06F 3/0485; H04L 29/06

(52) U.S. Cl. CPC G06F 3/1454; G06F 3/0482; G06F 3/0485; G06F 17/24; H04L 65/403; G06F 2203/04806; H04L 65/1069

(57) ABSTRACT

Embodiments of the present invention include methods and systems for sharing content in a group slideshow. A plurality of devices, including at least one host device and one or more participant devices, executes a client application by which users can save and organize a plurality of content items on a server storage system. The host can select two or more content items for inclusion in a group slideshow session. With each selection, the server automatically transmits participant copies of the content items to participants, and the participants' client applications automatically display the content items. The participants can view and interact with (e.g., zoom in, save, edit) their respective copies of the content items. When the host adds more content items to the group slideshow session, the participants can catch up to see the content item that the host is currently viewing.

This application claims the benefit of U.S. Provisional Patent Application 62/740,264, filed 2 Oct. 2018.

### BACKGROUND AND SUMMARY OF THE INVENTION

Despite the ubiquity of smartphones and myriad ways of sharing content on social media, there is still a tendency for people to physically pass their phones around a group when they want to share and discuss some content in real time. For example, a small group of friends at dinner might be discussing a wedding they recently attended. One or more of the friends may have photos, videos, and/or websites from or about the wedding that they want to share. Currently, the person sharing the content (referred to below as the “host”) has several options.

First, they can pass their phone (or other smart mobile device) to each person in the group. This is inefficient, a bit awkward, and can take a lot of time if there are more than a few content items to review.

Second, they can post all the content to social media. This is ineffective due to a lack of organization or synchronicity. Among hundreds or thousands of posts, it can be difficult for others to find and follow along with the specific content items being discussed.

Third, they can cast their screen to a larger display (e.g., a nearby TV). This works well for real-time viewing, but only when the host has access to another display that is sufficiently private for the intended audience. The people viewing the content (referred to as the “participants”) also have no way to look at the content again at a later time or independently view other items being shared.

Embodiments of the current invention provide a fourth option that permits the host to quickly invite one or more participants to a group slideshow via their respective mobile devices. Upon joining the group slideshow, participants can follow along as the host advances through a variety of content items; independently navigate back and forth through the content items in the group slideshow if they want to spend more or less time viewing a particular item; save content items of interest for future viewing; add new content items to the slideshow in real time; and react (e.g., via interactive features) to the content items being shared.

Embodiments of the invention also include other inventive features and functionality described in more detail below.

### BRIEF DESCRIPTION OF THE DRAWINGS

The invention is explained in further detail, and by way of example, with reference to the accompanying drawings wherein:

FIG. 1 illustrates a block diagram of an embodiment of a multi-user slideshow system.

FIG. 2 illustrates a block diagram of an embodiment for a computer-implemented method of providing a group slideshow.

FIGS. 3A-3F illustrate embodiments of the invention as implemented in client software on a mobile device.

### DETAILED DESCRIPTION

In the following description, for purposes of explanation rather than limitation, specific details are set forth such as the particular architecture, interfaces, techniques, etc., to provide a thorough understanding of the concepts of the invention. However, it will be apparent to those skilled in the art that the present invention may be practiced in other embodiments that depart from these specific details. In like manner, the text of this description is directed to the example embodiments as illustrated in the Figures, and it is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

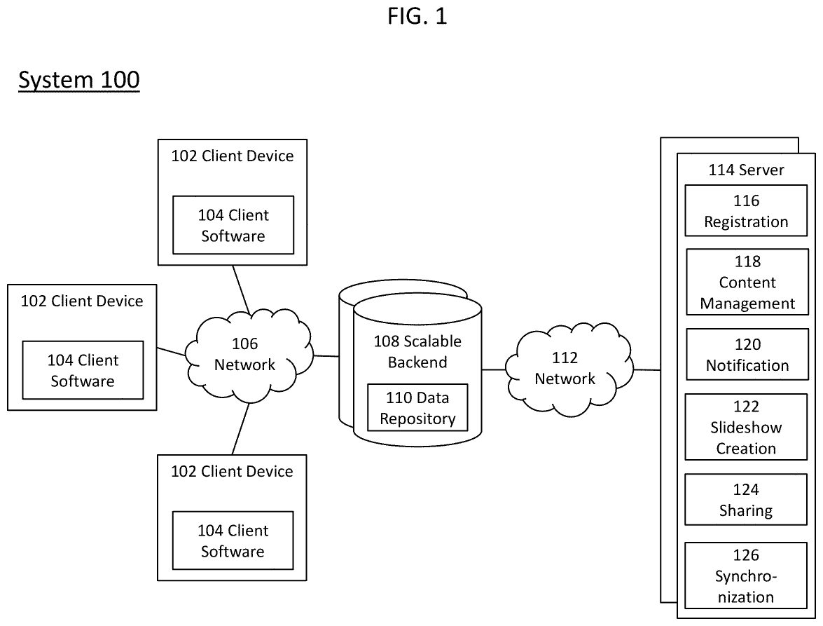

As illustrated in FIG. 1, embodiments of the invention include a multi-user slideshow system 100, which includes a plurality of client devices 102, one or more networks 106 and 112, a scalable backend 108 with a data repository 110, and a server system with one or more virtual workers 114. In such embodiments, the multi-user slideshow system comprises client software 104 executing on each of the client devices 102.

In embodiments, client devices 102 are mobile phones (e.g., running Google Android or Apple iOS operating systems), tablets, or similar consumer devices. Client devices 102 can also be desktop or notebook computers (e.g., running Windows or MacOS operating systems), or other devices capable of executing software applications like web browsing software.

In embodiments, client software 104 is a mobile application (e.g., an “app” downloadable from the Google Play Store or Apple App Store), a desktop application, or a cloud-based application that, for example, executes within a web browser. Client software 104 enables users to save content of interest to local and/or remote (e.g., cloud) storage. The content can include any type of media such as web links, photos, notes, documents (e.g., Word and PDF), and videos. Client software 104 also permits users to save their content into one or more folders. In embodiments, users can create hierarchical folder structures. For example, a user may have a top-level folder called “Travel,” and in that folder, they may have various sub-folders with content related to different places the user visited or is planning to visit. Client software 104 may be written in JavaScript, Java, Objective-C, Swift, or any other programming language supported by client devices 102. In embodiments, client software 104 is a mobile application called BUBLUP provided by Bublup, Inc.

In embodiments, client devices 102 interact with the scalable backend 108 via network 106. In embodiments, network 106 is the Internet, but can be any other type of network capable of supporting communications between the client devices 102 and the scalable backend 108.

In embodiments, scalable backend 108 can be a conventional server system or a cloud-based server system (e.g., Amazon Web Services). Scalable backend 108 may include one or many hardware devices and may be configured to grow (i.e., make more computing resources available) according to the number of client devices 102 in system 100. Scalable backend 108 includes a data repository 110 and provides services such as authentication, real-time database operations, file storage, and analytics. Client software 104 uses these services to, for example, authenticate users, store user data and files, and track user actions. The real-time database service provided by scalable backend 108 ensures that all its connected clients stay current with changes to the underlying data. All instances of client software 104 are clients of the real-time database. Data repository 110 can be one or more storage devices on one or more servers configured to store data in support of system 100.

In embodiments, scalable backend 108 communicates with server system 114 via network 112, which can be a service provider's private network, the Internet, or any other type of network capable of supporting communications between scalable backend 108 and server system 114. In embodiments, scalable backend 108 and server system 114 are located on the same physical device(s) and network 112 is not needed. Like scalable backend 108, server system 114 may include one or many hardware devices and can be implemented virtually in one or more other server systems.

In embodiments, server system 114 includes a plurality of virtual workers like registration 116, content management 118, notification 120, slideshow creation 122, sharing 124, and synchronization 126. Virtual workers comprise one or more software libraries (written in Java, Scala, Ruby, or any other programing language supported by server system 114) and perform background jobs such as creating new slideshow sessions and sending invitations to participants. There is a different worker for each kind of background task that is performed by server system 114. In embodiments, each of the workers is also a client of a real-time database running on scalable backend 108, and the client software 104 creates tasks and receives results from the workers via the real-time database.

In embodiments, users of client software 104 register a new account before they can begin using the software. Users can, for example, register with an email address, social media account, or other information personal to them. Registration worker 116 interfaces with client software 104 via scalable backend 108 to process new user registration and create corresponding user records in data repository 110. Registered users can invite others to use client software 104 and create contact lists comprising contact information for other users.

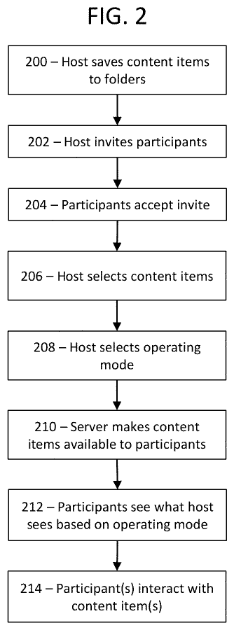

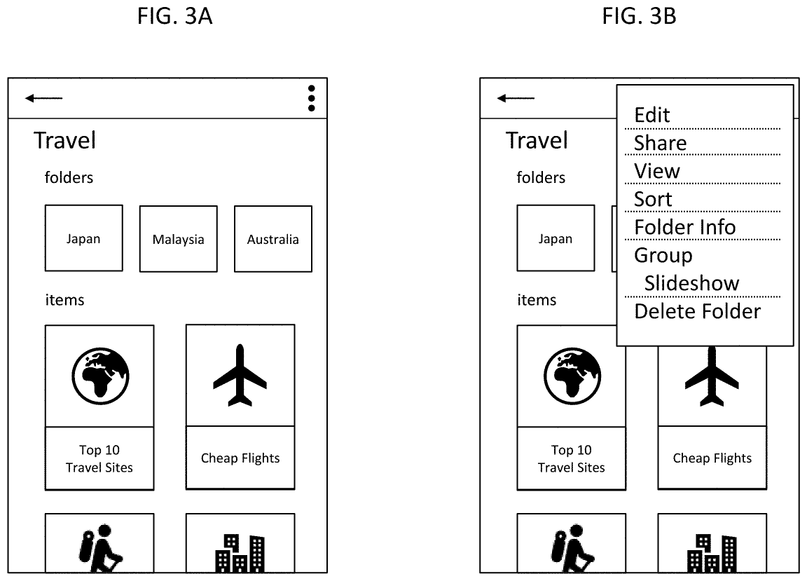

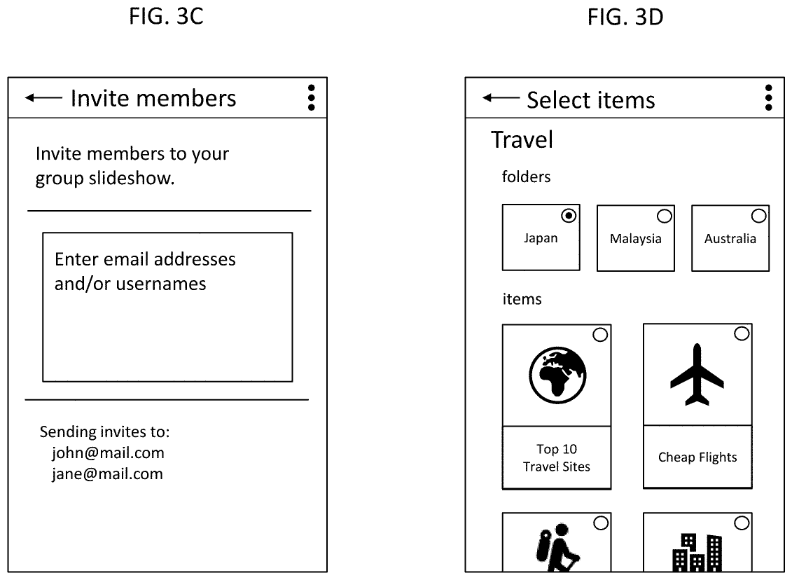

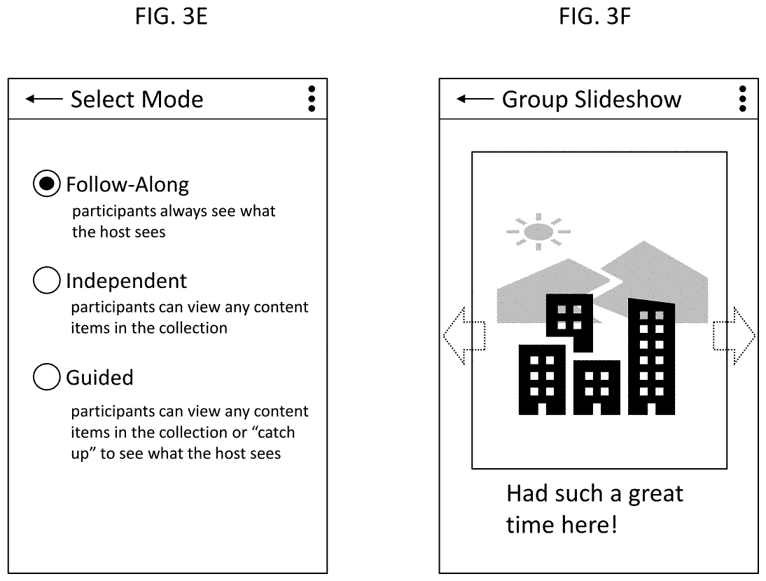

FIG. 2 illustrates embodiments for a computer-implemented method of providing a group slideshow. At step 200, a user of client software 104 saves one or more content items to one or more folders. For example, the user may have created a folder called “Travel” within client software 104, and the user can save links, pictures, documents, etc. about places of interest to that folder and/or one or more subfolders. Client software 104 interfaces with content management worker 118 via scalable backend 108 to store folders and content in data repository 110. FIG. 3A illustrates an example embodiment of client software 104 in which the user created a top-level folder called “Travel” and three sub-folders called “Japan,” “Malaysia,” and “Australia.” The user has also saved a plurality of content items (e.g., “Top 10 Travel Sites”) to the “Travel” folder and the subfolders.

Once the user has saved some content, they can choose to host a group slideshow. FIG. 3B illustrates an example embodiment of client software 104 in which the user can, among other things, select “Group Slideshow” from a menu of functions. For clarity, the user starting a group slideshow will be referred to simply as the “host” throughout the remainder of this description. Upon the host's initiation of a new group slideshow, slideshow creation worker 122 interfaces with scalable backend 108 to create a new slideshow session in the real-time database. Each group slideshow session corresponds to a unique instance of a group slideshow.

At step 202, the host invites one or more other users (“participants”) to the group slideshow. In embodiments, the host can select participants from one or more contact lists, enter email addresses or usernames for participants, or use other criteria for identifying participants. In the same or alternative embodiments, the host could utilize a user or software-generated passcode to invite participants. The passcode could be selected by the host or generated by client software 104. When generated by client software 104, the passcode can, for example, be a random string of characters or some random characters combined with characters specific to the host (e.g., the host's username). In these embodiments, the host could simply inform participants of the passcode (e.g., verbally, via text, email, or in-app message, etc.), and each participant would enter the code into client software 104 to join the slideshow. In embodiments, client software 104 may use additional criteria to enable participants to join a group slideshow. For example, location services such as GPS can be used to enable participation by only those participants within close physical proximity to the host. Location services can also be used to suggest nearby participants to the host when initiating a new group slideshow session. For example, location services could be used to track the geographic locations of users of the client software 104 (via GPS hardware and software in their respective mobile devices), and client software 104 could automatically suggest nearby users as possible participants.

FIG. 3C illustrates an example embodiment of client software 104 in which the host can invite one or more participants by entering email addresses and/or usernames. Client software 104 interfaces with notification worker 120 via scalable backend 108 to send electronic invitations to the selected participants by email, SMS message, push notification, in-app notification, or other conventional method. Participants can then accept or decline the invitation, for example by selecting a link in an email or text message, replying to the text message, or interacting with the notification. Participants who accept the invitation at step 204 are then added to a group slideshow session. In embodiments, if a participant does not already have client software 104 installed on their respective client device 102, then they may be prompted to install client software 104 and register before joining the group slideshow session.

At step 206, the host selects one or more of their saved content items to share with participants. In embodiments, the host selects one item at a time to be shared with the participants in real time. The host can alternatively select folders (including subfolders) and/or a plurality of items to be added to an ad hoc collection. In the same or alternative embodiments, the host can preselect one or more content items before starting a new slideshow session, in which case step 206 would precede step 202. The one or more content items selected by the host either before or during a slideshow session make up the “slideshow collection.” FIG. 3D illustrates an example embodiment of client software 104 in which the host can select one or more items and/or folders to include in the slideshow collection. In embodiments, when selecting the “group slideshow” menu option in FIG. 3B, client software 104 can automatically add all items in the current folder and all subfolders to a slideshow collection.

A group slideshow session can operate in one or more of a plurality of modes. The present invention contemplates at least three different modes of operation: follow-along mode, independent mode, and guided mode. In follow-along mode, each participant sees what the host sees, similar to a traditional slideshow. In other words, if the host is currently viewing a web link about Tokyo, then the participant will see the same link. The participant has no ability to access other content items in the slideshow collection.

In alternative embodiments, participants in follow-along mode see the most recent content item that the host posted (i.e., selected for inclusion in the slideshow) rather than the content item that the host is currently viewing. In this manner, the host can browse through other folders and items in their personal library and determine what to post next while the participants view the currently posted content item. In the same or alternative embodiments, the host can add selected content items to a queue during the group slideshow session. The host can then independently (i.e., via separate controls in client software 104) navigate through the items in the queue, thereby changing what the participants see. At any time during the slideshow, the host can add more content items from their personal library to the queue.

In independent mode, each participant has access to all items in the slideshow collection. So even if the host is currently viewing a web link about Tokyo, the participant may navigate to other posted items in the collection like, for example, a picture taken in Kuala Lumpur.

In guided mode, the participant sees what the host sees when the host selects a new item to view or posts a new content item to the collection. But instead of being limited to just that item, the participant may then navigate to other posted items in the collection. At any time, the participant can then “catch up” with the host, for example, by selecting a corresponding function in client software 104, and return to the item that the host is currently viewing or has most recently posted. In embodiments, the participant could automatically catch up with the host whenever the host selects a new item to view or post, and/or the participant could receive an alert upon such an event.

At step 208, the host selects the desired operating mode while creating a new group slideshow session, and the participants must view the slideshow in accordance with the selected mode. In the same or alternative embodiments, each participant can select (via client software 104) the operating mode by which they want to view the group slideshow. FIG. 3E illustrates an example embodiment of client software 104 in which the host selects the operating mode.

In conventional conferencing and screen sharing applications, participants view live video or screen captures of what the host is sharing. In other words, if the host is sharing a picture, the participants see a replication of what the host sees. Such replications often come at a cost of reduced clarity, and the participants' views are at the very least limited to the same resolution that the host has selected for viewing the picture. In such applications, participants also cannot view any metadata (e.g., the date and time that a picture was taken) that accompanies the content being shared, unless the host specifically chooses to share the metadata.

In a group slideshow session, however, participants can view the actual content items, including any corresponding metadata. For example, if the host has selected a content item that is a picture, then at step 210, sharing worker 124 interfaces with scalable backend 108 to make that picture directly accessible to the participant's client software 104. For example, sharing worker 124 can grant the participant's client software permission to download the picture from data repository 110. Likewise, if the host is sharing a collection of content items, sharing worker 124 can provide viewing permissions to the participant's client software 104 for each item in the collection. In this manner, a participant can view and interact with items as data objects rather than just blocks of pixels.

In addition to viewing metadata, participants can interact with content items by adding feedback to the content items. In embodiments, client software 104 permits participants to add feedback to a content item through comments and/or reactions. Comments are custom, typed responses while reactions are selected from a predefined list. Reactions, for example, can include likes, dislikes, approvals, etc. and can be represented by words, phrases, icons, and/or other graphical indicators. Feedback is associated and saved with the original content item shared by the host so that it can be viewed by the host as well as participants with access to the item.

At step 212, the slideshow is active, and participants will see what the host sees depending on the selected operating mode. In follow-along mode, for example, when the host selects a content item from the collection, synchronization worker 126 interfaces with scalable backend 108 to instruct the client software 104 for each participant to download (from scalable backend 108) and display the selected content item. FIG. 3F illustrates an example embodiment of client software 104 in which a selected item is displayed for hosts and participants within a group slideshow. As the host navigates to a new content item, for example by selecting one of the left or right arrows in FIG. 3F, synchronization worker 126 interfaces with scalable backend 108 to instruct the client software for each participant to download and display the new content item. This process repeats until the end of the group slideshow.

In alternative embodiments, participants in follow-along mode will see the most recent item that the host posted to the slideshow session. In such embodiments, when the host posts a new content item to the slideshow session (e.g., by selecting a “post to slideshow” menu function associated with the content item), synchronization worker 126 interfaces with scalable backend 108 to instruct the client software 104 for each participant to download (from scalable backend 108) and display the posted content item. This process repeats until the end of the group slideshow.

If the host selected independent mode, then each participant may individually navigate to each content item in the collection at their own pace. With each navigation to a new content item, a participant's client software 104 will download the corresponding item from data repository 110. This process continues until the end of the slideshow. In embodiments, client software 104 can provide a small preview window for participants within the primary display. The preview window behaves like picture-in-picture functionality in that it displays the content item currently selected by the host when the participant has navigated to another item in the collection. In this manner, the participant can easily see when the host has selected a new content item. In embodiments, the preview window can be resized, minimized, maximized, or hidden completely as desired by the participant.

If the host selected guided mode, then each participant will see what the host sees, but has the option to navigate to other content items in the collection. Unlike independent mode, however, when the host navigates to a new content item, the participant's client software 104 will revert back to seeing what the host sees. When the host selects a new content item, participant's client software 104 will download the corresponding item from data repository 110. This process continues until the end of the slideshow. In all modes of operation, if a participant or host navigates to a content item that has already been downloaded to client software 104, it is not necessary to download the item again.

In embodiments, instead of participants downloading original content items, scalable backend 108 can transmit optimized versions of content items to participants to reduce bandwidth and storage needs. Participants can, however, still interact with the content items (e.g., comment, react, view metadata, etc.) as if they were the original content items. Participants can also obtain the original content items by saving them to their own personal folders or explicitly requesting the original content items via a corresponding function in client software 104. Techniques for optimizing different types of files (e.g., images, audio, and video) are well known in the art.

In embodiments, where the content item is video or audio, client software 104 can stream the content from scalable backend 108 rather than downloading the entire file. This may be especially useful for large files. In embodiments, the host can control the playing of the video or audio item through player controls embedded in client software 104. When participants are in a follow-along mode, for example, the host can then play, pause, rewind, and fast forward the presentation of the audio or video item and the participants will see/hear exactly what the host is seeing/hearing. In such embodiments, synchronization worker 126 interfaces with scalable backend 108, which in turn instructs the participants' client software 104 to play the audio or video file in synchrony with the host.

Once a content item has been transmitted to a participant's client software 104 (either in original or optimized form), the participant can, at step 214, interact directly with the content items. For example, participants can zoom in and out of pictures, independently control videos (e.g., pause, rewind, fast-forward, etc.), scroll through documents, launch web links and browse the corresponding web pages, save the content items to their own personal folders (e.g., by clicking a “save” button next to an item they like), and add feedback through comments and/or reactions. For clarification, it should be understood that when a participant's client software 104 downloads an original content item or an optimized version of the content item, it is downloading a copy of the content item. If the participant changes the content item in any way, those changes are restricted to that participant's copy, unless they are meant to propagate to the host's copy (e.g., comments and reactions).

While participating in a group slideshow session, participants in some embodiments can add content items from their own personal folders to the slideshow. For example, a participant can activate a function within client software 104 to indicate that they want to share one or more content items, folders, and/or collections. In embodiments, the host can approve or deny the participant's request to share content items. If approved, or if no approval is necessary, the participant can become a temporary host.

In the same or alternative embodiments, a slideshow can have multiple simultaneous hosts. Each host can share their own items, folders, and/or collections, and all could be added to a common collection visible to all participants. In such embodiments, participants in a follow-along mode can, for example, see the content item most recently selected by any of the hosts.

The foregoing merely illustrates the principles of the invention. It will thus be appreciated that those skilled in the art will be able to devise various arrangements which, although not explicitly described or shown herein, embody the principles of the invention and are thus within its spirit and scope. These and other system configuration and optimization features will be evident to one of ordinary skill in the art in view of this disclosure and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and it does not imply any particular range of number of elements; that is, a plurality of elements can be as few as two elements, and can include an immeasurable number of elements.

We claim:

1. A computer-implemented method for sharing content in a group slideshow, comprising:
receiving input from a host at a client application to:
save a plurality of content items to one or more folders for storage on a server;
initiate a group slideshow session from the one or more folders;
select a plurality of participants for the group slideshow session;
select a first content item from the plurality of content items for display in the group slideshow session; and
select a second content item from the plurality of content items for display in the group slideshow session;
notifying the plurality of participants, all of whom are executing the client application, of the group slideshow session;
for a participant of the plurality of participants:
receiving input at the participant's client application to join the group slideshow session;
in response to the host selecting the first content item:
automatically transmitting a participant's copy of the first content item from the server to the participant's client application; and
automatically displaying the participant's copy of the first content item in the participant's client application;
in response to the host selecting the second content item:
automatically transmitting a participant's copy of the second content item from the server to the participant's client application; and
automatically displaying the participant's copy of the second content item in the participant's client application;
receiving input at the participant's client application to navigate back to the participant's copy of the first content item; and
receiving input at the participant's client application to save the participant's copy of the first content item to a folder managed by the participant on the server.

2. The method of claim 1, further comprising:
receiving input from the host at the host's client application to select a third content item from the plurality of content items for display in the group slideshow session;
automatically transmitting a participant's copy of the third content item from the server to the participant's client application; and
automatically displaying the participant's copy of the third content item in the participant's client application, regardless of whether the participant navigated to the participant's copy of the first content item.

3. The method of claim 1, further comprising:
receiving input from the host at the host's client application to select a third content item from the plurality of content items for display in the group slideshow session;
automatically transmitting a participant's copy of the third content item from the server to the participant's client application;
receiving input at the participant's client application to catch up to the group slideshow session; and
in response to the input to catch up to the group slideshow session, automatically displaying the participant's copy of the third content item in the participant's client application.

4. The method of claim 3, wherein the participant's client application includes a preview window that displays the participant's copy of the third content item until the participant provides the input to catch up to the group slideshow session.

5. The method of claim 1, wherein the first content item is a picture, and wherein the method further comprises receiving input at one or more of the participants' client applications to zoom into the participant's copy of the first content item.

6. The method of claim 1, wherein the first content item is a video, and wherein the method further comprises receiving input at one or more of the participants' client applications to pause, rewind, or fast-forward the participant's copy of the first content item.

7. The method of claim 1, wherein the first content item is a web link, and wherein the method further comprises receiving input at one or more of the participants' client applications to launch the web link in a browser window.

8. The method of claim 1, wherein the first content item is a document, and wherein the method further comprises receiving input at one or more of the participants' client applications to scroll through and edit the document.

9. The method of claim 1, further comprising:
receiving input at the participant's client application to select a participant content item from a personal folder for display in the group slideshow session;
in response to the participant selecting a participant content item, automatically transmitting a participant's copy of the participant content item to the host's client application and each of the other participants' client applications; and
automatically displaying the participant's copy of the participant content item in the host's client application and each of the other participants' client application.

10. A system for sharing content in a group slideshow, comprising:
a server, wherein the server includes one or more virtual workers;
a host device, wherein the host device executes a client application configured to:
receive input from the host to:
save a plurality of content items to one or more folders for storage on the server;
initiate a group slideshow session from the one or more folders;
select a plurality of participants for the group slideshow session;
instruct the server to notify the plurality of participants of the group slideshow session;
select a first content item from the plurality of content items for display in the group slideshow session; and
select a second content item from the plurality of content items for display in the group slideshow session;
a plurality of participant devices, wherein each participant device executes the client application, which is further configured to:
receive input to join the group slideshow session;
in response to the host selecting the first content item:
automatically receive a participant's copy of the first content item from the server; and
automatically display the participant's copy of the first content item;
in response to the host selecting the second content item:
automatically receive a participant's copy of the second content item from the server; and
automatically display the participant's copy of the second content item;
receive input to navigate back to the participant's copy of the first content item; and
receive input to save the participant's copy of the first content item to a folder on the server.

11. The system of claim 10, wherein the client application is further configured to:
at the host device, receive input from the host to select a third content item from the plurality of content items for display in the group slideshow session; and
at the participant devices, automatically receive a participant's copy of the third content item from the server; and
automatically display the participant's copy of the third content item, regardless of whether the participants have navigated to the participant's copy of the first content item.

12. The system of claim 10, wherein the client application is further configured to:
at the host device, receive input from the host to select a third content item from the plurality of content items for display in the group slideshow session;
at the participant devices, automatically receive a participant's copy of the third content item from the server;
receive input to catch up to the group slideshow session; and
in response to the input to catch up to the group slideshow session, automatically display the participant's copy of the third content item.

13. The system of claim 12, wherein the participant's client application includes a preview window that displays the participant's copy of the third content item until the participant provides the input to catch up to the group slideshow session.

14. The system of claim 10, wherein the first content item is a picture, and wherein the client application is further configured to receive input from one or more of the participants to zoom into the participant's copy of the first content item.

15. The system of claim 10, wherein the first content item is a video, and wherein the client application is further configured to receive input from one or more of the participants to pause, rewind, or fast-forward the participant's copy of the first content item.

16. The system of claim 10, wherein the first content item is a web link, and wherein the client application is further configured to receive input from one or more of the participants to launch the web link in a browser window.

17. The system of claim 10, wherein the first content item is a document, and wherein the client application is further configured to receive input from one or more of the participants to scroll through and edit the document.

18. The system of claim 10, wherein the client application is further configured to:
receive input from a participant to select a participant content item from a personal folder for display in the group slideshow session; and
at the host device and each of the other participants' devices:
in response to the participant selecting a participant content item, automatically receive a participant's copy of the participant content item; and
automatically display the participant's copy of the participant content item.
